(19) United States
(12) Patent Application Publication
(10) Pub. No.: US 2015/0100349 A1
(43) Pub. Date: Apr. 9, 2015

(54) Untethered Community-Centric Patient Health Portal

(71) Applicant: ZIRMED, INC., Louisville, KY (US)

(72) Inventors: James Scott Lacy, Shelbyville, KY (US); Douglas R. Fielding, Finchville, KY (US); Eric L. Sinclair, III, Louisville, KY (US)

(21) Appl. No.: 14/499,776

(22) Filed: Sep. 29, 2014

Related U.S. Application Data
(60) Provisional application No. 61/887,566, filed on Oct. 7, 2013.

(51) Int. Cl. G06F 19/00

(52) U.S. Cl. CPC G06F 19/322; G06F 19/3456; G06F 19/3475
USPC 705/3

(57) ABSTRACT

A method is disclosed for providing online access to patient healthcare information. The method includes receiving patient healthcare information electronically for each of a plurality of patients from a plurality of healthcare providers and from a plurality of healthcare payers, wherein said healthcare information includes clinical data and financial information relating to a healthcare event in which a patient received healthcare treatment for a condition; providing a platform which is accessible online and which is equipped with a graphical user interface (GUI) in which (a) the healthcare events associated with each of the plurality of patients are arranged along a timeline, and (b) the healthcare information received for that patient is linked to the healthcare event to which it corresponds; and providing online access to the platform to each of the plurality of patients.

### CROSS-REFERENCE TO RELATED APPLICATION

This application claims the benefit of U.S. provisional application No. 61/887,566, filed Oct. 7, 2013, having the same title, and which is incorporated herein by reference in its entirety.

### FIELD OF THE DISCLOSURE

The present disclosure relates generally to healthcare management, and more particularly to community based patient health portals.

### BACKGROUND OF THE DISCLOSURE

The Health Information Technology for Economic and Clinical Health (HITECH) Act provides the Department of Health & Human Services (HHS) with the authority to establish programs to improve health care quality, safety, and efficiency through the promotion of healthcare related information technology (IT). Such healthcare related IT includes electronic health records, and the private and secure exchange of electronic health information. Under HITECH, eligible healthcare professionals and hospitals can qualify for Medicare and Medicaid incentive payments when they adopt certified Electronic Medical Record (EMR) technology (also referred to as Electronic Health Record (EHR) technology) and use it to achieve specified objectives.

A set of standards referred to as “meaningful use” has been defined by the Centers for Medicare & Medicaid Services (CMS) Incentive Programs that govern the use of EMRs. These standards allow eligible healthcare providers and hospitals to earn incentive payments by meeting specific criteria. The goal of meaningful use is to promote the spread of electronic health records to improve health care in the United States. To date, HHS has released regulations which define the meaningful use objectives that providers must meet in order to qualify for the bonus payments, and which identify the technical capabilities required for certified EMR technology.

One of the goals of the meaningful use of EMRs is to provide complete and accurate healthcare information. This will ensure that healthcare providers will have the information they need to provide the best possible care for patients, and will allow healthcare providers will know more about their patients and their health history before they walk into the examination room.

Another goal of the meaningful use of EMRs is to provide better access to healthcare information. The use of electronic health records has the potential to facilitate greater access to the information that healthcare providers need to diagnose health problems earlier, and to improve the outcome of medical treatment for patients. The use of electronic health records also has the potential to allow information to be shared more easily among physician offices and hospitals and across healthcare systems, which in turn may lead to better coordination of healthcare services for a patient.

Yet another goal of the meaningful use of EMRs is patient empowerment. Electronic healthcare records have the potential to help empower patients to take a more active role in their healthcare. In particular, EMRs provide the ability for patients to receive electronic copies of their medical records, and to share these records securely (over the Internet or via other networks) with their families, friends and other interested parties.

A further goal of the meaningful use of EMRs is to provide access by a patient to the patient's healthcare information arising from all of the patient's healthcare activities. In providing such access, it is also a goal of the meaningful use of EMRs to provide transparency and facilitate communications with the patient.

### BRIEF DESCRIPTION OF THE DRAWINGS

FIGS. 1-2 are screenshots from an embodiment of a software platform for collecting, storing and presenting patient healthcare information to various authorized audiences. These screenshots depict, respectively, upper and lower portions of the main (scrollable) window for the software.

FIG. 3 depicts the patient summary section of the window of FIGS. 1-2 in greater detail.

FIG. 4 depicts the hyperlink menu of the window of FIGS. 1-2 in greater detail.

FIG. 5 depicts the health timeline subsection of the window of FIGS. 1-2 in greater detail.

FIG. 6 depicts the medications subsection of the window of FIGS. 1-2 in greater detail.

FIG. 7 depicts the allergies subsection of the window of FIGS. 1-2 in greater detail.

FIG. 8 depicts the encounters subsection of the window of FIGS. 1-2 in greater detail.

FIG. 9 depicts the immunizations subsection of the window of FIGS. 1-2 in greater detail.

FIG. 10 depicts the plan of care subsection of the window of FIGS. 1-2 in greater detail.

FIG. 11 depicts the lab work subsection of the window of FIGS. 1-2 in greater detail.

FIG. 12 depicts the patient notebook section of the window of FIGS. 1-2 in greater detail.

### SUMMARY OF THE DISCLOSURE

In one aspect, a method is provided for providing online access to patient healthcare information. The method comprises (a) receiving patient healthcare information electronically for each of a plurality of patients from a plurality of healthcare providers and from a plurality of healthcare payers, wherein said healthcare information includes clinical data and financial information relating to a healthcare event in which a patient received healthcare treatment for a condition; (b) providing a platform which is accessible online and which is equipped with a graphical user interface (GUI) in which (i) the healthcare events associated with each of the plurality of patients are arranged along a timeline, and (ii) the healthcare information received for that patient is linked to the healthcare event to which it corresponds; and (iii) providing online access to the platform to each of the plurality of patients.

In another aspect, a method is provided for collecting and presenting healthcare information. The method comprises (a) collecting health records for a plurality of patients from a plurality of healthcare providers; and (b) for each patient, depicting the collected health records for that patient on a graphical user interface (GUI) which includes (i) a timeline showing a series of medical events for the patient, and (ii) for each medical event, a hyperlink to records associated with the medical event.

### DETAILED DESCRIPTION

Providing patients with the ability to access and share their medical records with others is critical to the implementation of meaningful use incentives. However, despite the HITECH and Meaningful Use incentives and the adoption of EMR technologies, in practice, the goal of allowing patients to easily access and share their medical records has still not been realized. This problem is due, in part, to the challenge of organizing healthcare data in a way which allows it to be shared readily and efficiently by patients, by their healthcare providers, and by other authorized parties. Here, it is to be noted that the data available for even a single patient may be considerable, and hence, the sheer amount of available data may obfuscate the overall picture of the patient's healthcare history and status. Moreover, different healthcare providers organize patient records in different ways, thus leading to inevitable translation costs when records are shared across the provider continuum.

The foregoing issues hinder the effective use of a patient's medical information. In particular, at present, healthcare personnel are often required to request records from multiple sources in order to obtain all of the data they need to treat a patient. Once this data is obtained, these personnel may then be required to sift through significant amounts of information simply to ascertain basic information about the patient. This situation is not conducive to efficiently recognizing trends in a patient's health, or to performing other higher level functions in the healthcare industry that leverage the patient's healthcare information, such as identifying potential drug interactions or allergies, or providing a patient with relevant healthcare information or education.

There are also some notable inefficiencies in sharing patient data under current practices. For example, personnel attempting to fulfill a request for medical records from another healthcare provider may have imperfect knowledge as to why the records are being requested, or which records are required to comply with the request. Indeed, the request itself may contain ambiguities. Hence, many records requests result in responses that contain records that are not needed by the requesting party, or result in important and relevant records being inadvertently omitted. This results in delays and wasted human resources, due to the processing of the unneeded records and/or the need for follow-up requests to obtain all of the necessary records.

In addition, the party initially requesting a patient's records may later realize, after reviewing the records provided, that additional records are required in order to treat or diagnose the patient. For example, upon reviewing the records provided, a doctor may realize that the patient had a preexisting medical condition that the doctor was previously unaware of This may necessitate requests for further records containing information about the condition, thus delaying the patient's ongoing healthcare.

There is thus a need in the art for an efficient and expedient system and methodology for sharing a patient's medical records. In particular, there is a need in the art for a system and methodology for sharing patient medical records that allows all necessary records to be shared among interested parties in an efficient and expedient manner, and that allows an interested party to quickly and efficiently obtain all records of interest to that party.

There is further a need in the art for a system and methodology for organizing a patient's medical records so that healthcare providers or other interested parties may quickly ascertain all significant medical events in the patient's history, and may readily examine medical events of interest with a desired level of granularity. In particular, there is a need in the art for a system and methodology for organizing a patient's medical records so that an interested party can quickly obtain a general overview of the events defining a patient's medical history, while still being able to drill down to a desired level of detail with respect to any particular event.

It has now been found that the foregoing needs may be met with the systems and methodologies disclosed herein. In a preferred embodiment of these systems and methodologies, a software-as-a-service (SaaS) platform is provided which is associated with a Revenue Cycle Management Company (RCMC). Because of this association, the platform may harness the power of the connected network of healthcare providers and healthcare payers associated with the RCMC—and may also harness the RCMC's unique position in the healthcare revenue cycle—to obtain healthcare information and records (both clinical and financial) related to a patient's medical history. This information may then be made available to the patient, and to healthcare providers and other parties authorized by the patient. Hence, the platform offers a single place that all interested parties may go to when such parties wish to obtain a patient's healthcare records.

It has also been found that the healthcare information exchanged over the platform from various data sources (financial and clinical) may be organized into a more meaningful and useful representation for the patient, for healthcare providers, or for other interested parties through the use of an intuitive graphical user interface (GUI) which provides both a general overview of the patient's medical history, and the means to obtain details about any events of interest. In a preferred embodiment, the data in the GUI is arranged chronologically, and is grouped into individual medical or life events which are depicted along a timeline. Hence, a user of the GUI may quickly grasp the patient's healthcare history, while also having the ability to drill down to a desired level of granularity through the use of submenus, hyperlinks and other such navigational features. The platform may be further equipped with a file transfer means which allows any authorized party to download any healthcare records of interest.

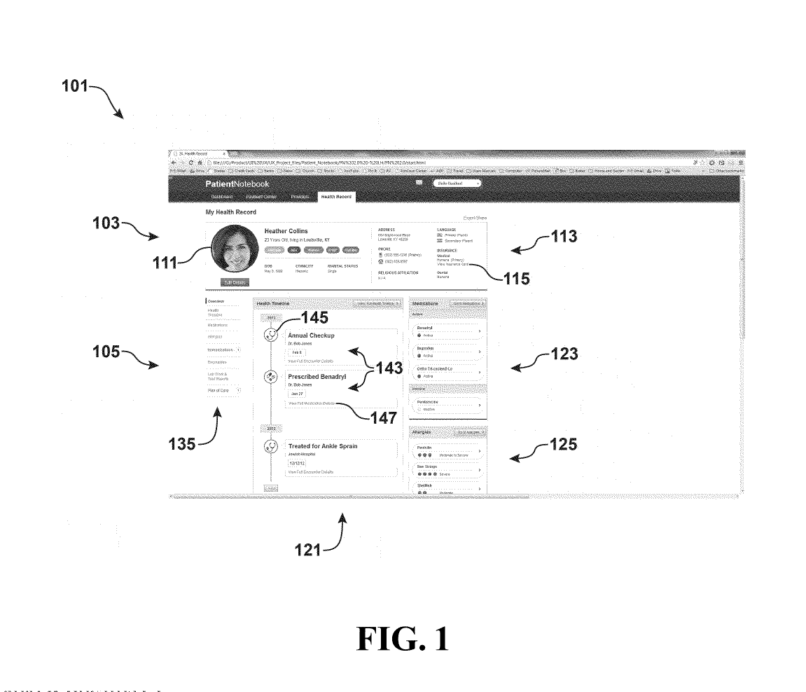

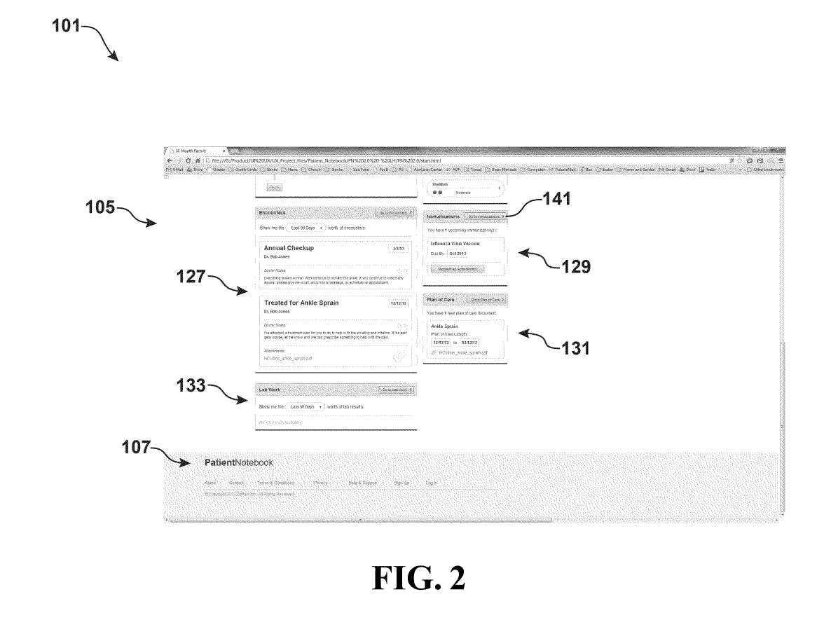

FIGS. 1-2 are screenshots showing the top and bottom sections of a web page from a particular, non-limiting embodiment of a platform containing a GUI in accordance with the teachings herein. The GUI 101 in this particular embodiment comprises a patient summary section 103 (see FIG. 1), a records section 105 (see FIG. 2) and a patient notebook section 107. In some embodiments, The GUI 101 may include a graphical indication of health and fitness trends for a patient.

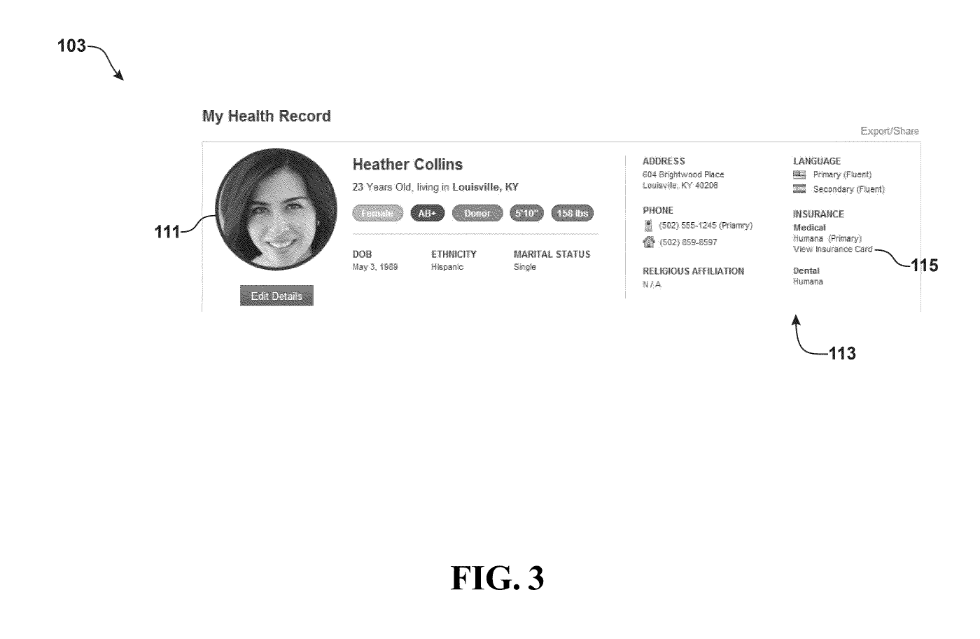

As seen in FIG. 1, the patient summary section 103 comprises various identifying characteristics of the patient. These include a picture 111 of the patient and the patient's basic information 113 (shown in greater detail in FIG. 3), the latter of which includes the patient's name, age, general address (e.g., city & state), sex, blood type, donor status, height, weight, date of birth, ethnicity, marital status, detailed address (e.g., street, city, state, zip), phone numbers (e.g., home and work), religious affiliation, language proficiencies, medical insurance plan, and dental plan.

Included in the patient's basic information 113 is a hotlink 115 to an image or electronic copy of the patient's medical insurance card. In some embodiments, this hotlink 115 may be utilized by the patient, or by healthcare providers authorized by the patient, to provide an electronic copy of the patient's medical insurance card, thus obviating the current need for the patient to provide this information on multiple forms when visiting a healthcare provider for the first time. For example, in some embodiments, when the patient or an authorized party selects the hyperlink 115, a pop-up screen is launched which displays an image of the patient's medical insurance card and provides a means to e-mail or text a copy of the card to a designated recipient, or to otherwise transfer an image of the card to a designated party. For example, the pop-up screen may contain a listing of healthcare providers associated with the patient or with the user (such association may be, for example, through the software associated with the GUI, or through an e-mail platform associated with the patient or user from which e-mail contacts may be accessed or imported), and selection of a healthcare provider from the list may automatically e-mail or transfer an image of the patient's medical insurance card to the selected healthcare provider.

In some embodiments, a software tool may be utilized which can access fields of text from the patient's medical insurance card (or which can use optical character recognition to read such text, if the medical insurance card is present as an image). The accessed information may then be utilized to populate the fields of standard healthcare forms with the relevant information. This tool may be provided, for example, as part of the software package, or may be utilized by a party receiving an electronic copy of a patient's medical insurance card in the manner described above.

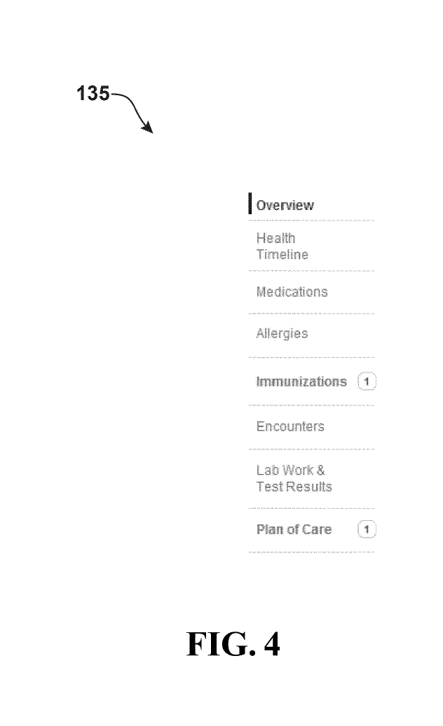

Referring again to FIGS. 1-2, the records section 105 preferably comprises a health timeline subsection 121, a medications subsection 123, an allergies subsection 125, an encounters subsection 127, an immunizations subsection 129, a plan of care subsection 131, and a lab work subsection 133. A hyperlink menu 135, which is shown in greater detail in FIG. 4, is provided to the left of the health timeline subsection 121, and provides a series of hyperlinks to each of the foregoing subsections. Selection of the hyperlink corresponding to any of these subsections takes the user to a page which shows a magnified view of the corresponding subsection. Preferably, however, the starting page is an overview in which all of these subsections are shown on a single, scrollable page. Similarly, each section is preferably equipped with a hyperlink in the form of a tab 141 which is linked to a page showing a magnified view of the corresponding subsection.

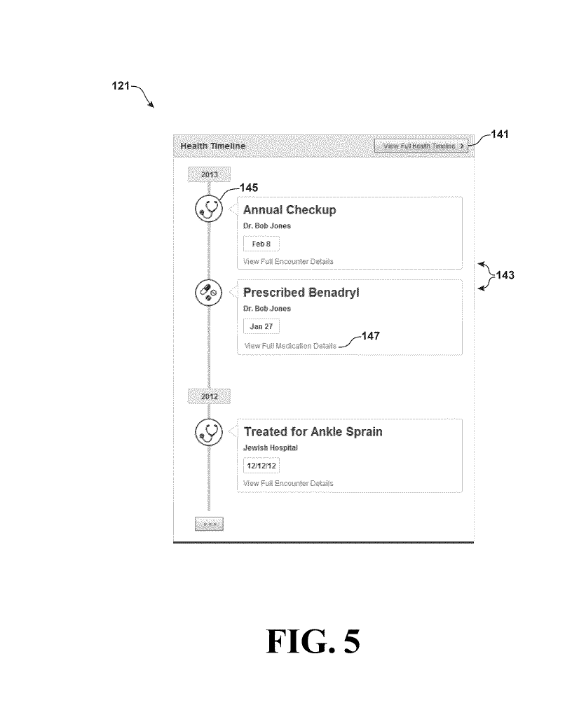

The health timeline subsection 121, which is shown in greater detail in FIG. 5, graphically depicts, in chronological order, the major events 143 in the patient's medical history. Each event preferably has an icon 145 associated with it which signifies the general nature of the event. Thus, for example, in the particular embodiment depicted, a stethoscope icon is used to indicate visits to a physician, while a capsule icon is used to indicate the issuance of a prescription. A textual description of the event is provided, along with the date of the event and the name of the responsible physician.

A user may view the details of each event by selecting the associated “View Full <event> Details” hotlink 147. Doing so takes the user to a page on which the details of the associated event are provided, and from which any associated healthcare records may be accessed. In a preferred embodiment, a user with appropriate authority may then view, copy, print, save, transmit or download these records.

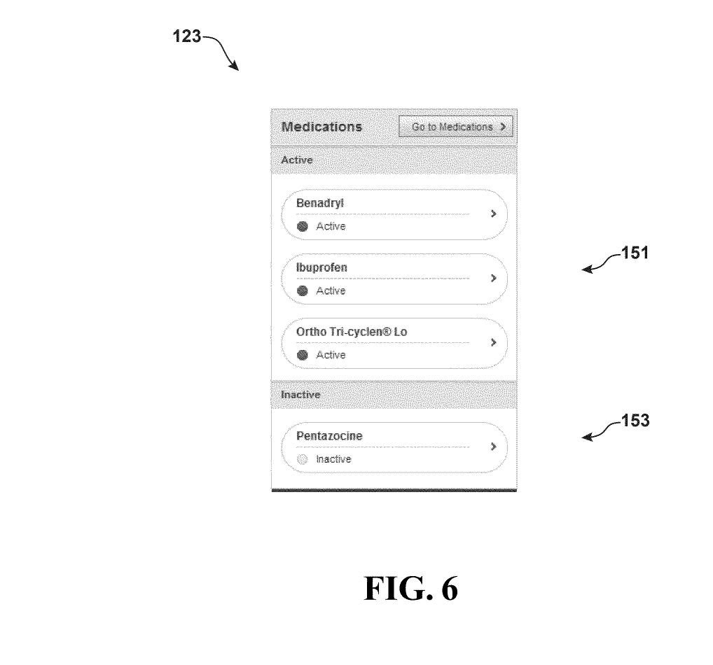

The medications subsection 123, which is shown in greater detail in FIG. 6, includes information about any medications that have been prescribed for the patient. This subsection includes a listing of each prescribed medication, along with the current status of each prescription (active or inactive). The medications are separated into active 151 and inactive 153 groups, thus allowing a user to readily ascertain which medications the patient is currently taking and, if necessary, which medications the patient has taken in the past.

A user may select any of the medications to view further details about it. Such details may include, for example, the date on which the medication was prescribed, the identity of the physician who wrote the prescription, the date on which the prescription expires, the reason the prescription was issued, common side effects of the medication, possible interactions with other medications or foods, activities the patient should refrain from while taking the medication, the manner in which the medication should be taken (including, for example, the frequency with which the medication should be taken and whether the medication should be taken with food), and other such information. In some embodiments, warnings may be generated if the patient has been prescribed two or more medications that have the potential to interact with each other.

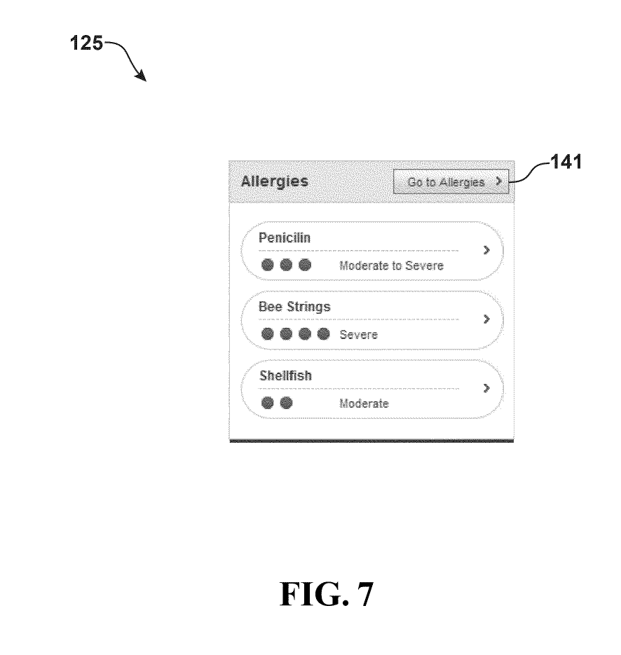

The allergies subsection 125, which is shown in greater detail in FIG. 7, includes a listing of any known allergies the patient has. The severity of the allergy is preferably indicated both graphically and textually. Each of the allergies listed preferably includes a hyperlink to a web page with further information so that a user may select the hyperlink to view further details about a given allergy. Such further details may include treatments for the allergy, sources of the allergen (for example, a listing of common foods or environments containing the allergen or common sources of the allergen), allergen alerts (for example, if the patient is allergic to ragweed pollen, this may include alerts or notifications when the current location at which the user resides is experiencing high levels of ragweed pollen), common symptoms or manifestations of the allergy, and the like.

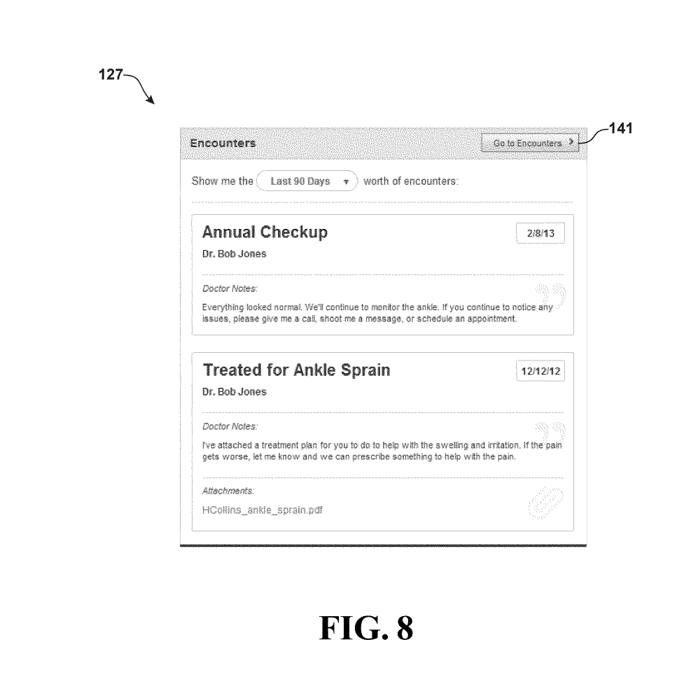

The encounters subsection 127, which is shown in greater detail in FIG. 8, includes a listing of all medical events that the patient has healthcare records for. Each medical event of record for the patient is listed in this section, along with a descriptive title, a brief textual description of the event, the date of the event, and the name of any associated physicians or healthcare providers. Any medical records associated with the event are preferably attached by way of suitable hyperlinks, and hence can be viewed (and in some embodiments, shared, downloaded, or copied) by a user. The encounters subsection 127 is preferably equipped with a date menu that allows the user to select a time period of interest over which to view the patient's medical history. After selection of such a time period, all of the events falling within that time period are listed in the subsection.

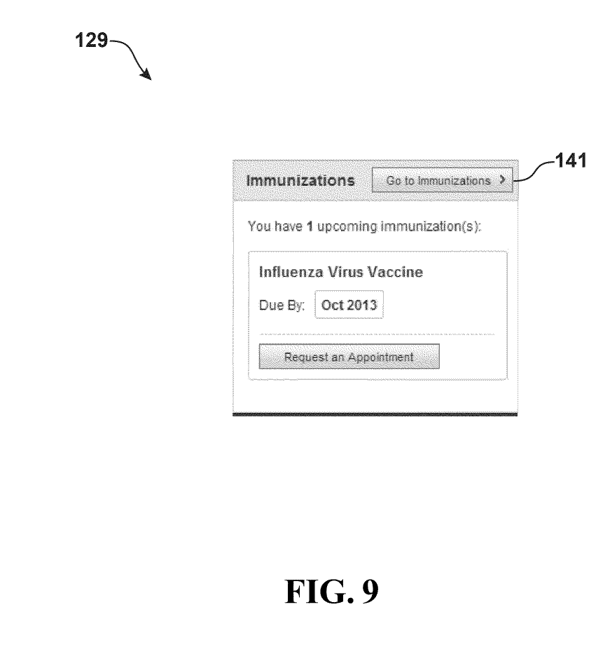

The immunizations subsection 129, which is shown in greater detail in FIG. 9, lists any upcoming immunizations scheduled or recommended for the patient. An indication of the number of upcoming immunizations is provided in this subsection, and a textual description and due date for each immunization is noted. A “Request an Appointment” tab is provided which, when selected, launches a web page from which the user may request an appointment with a suitable healthcare provider for administration of the upcoming immunizations. In some embodiments, the resulting listing may be sorted in various manners. For example, the healthcare providers may be listed according to their geographic proximity to the user, their experience with the patient, the type of insurance they accept, or in other manners. A “Go to Immunization” tab 141 is also provided, the selection of which launches a page from which the details of the patient's past and present immunizations may be viewed.

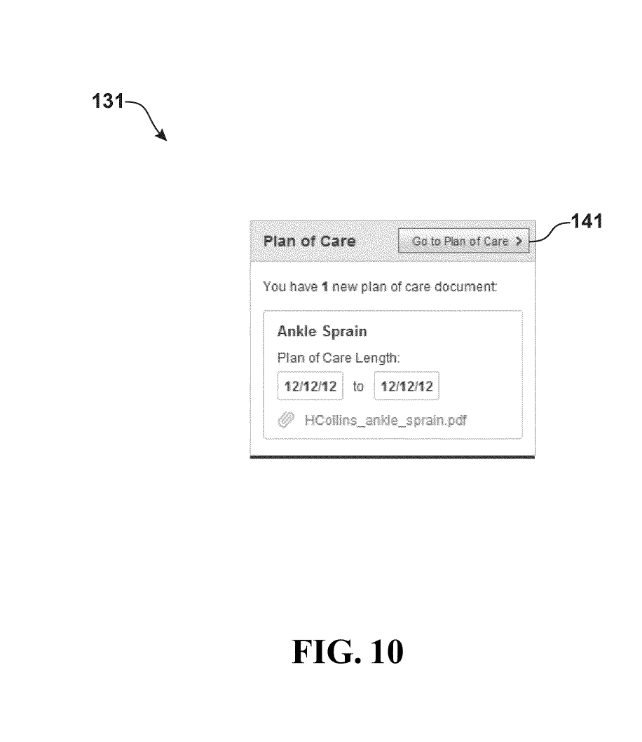

The plan of care subsection 131, which is shown in greater detail in FIG. 10, lists information for any plan of care (such as a regiment of therapy sessions or pharmaceuticals) prescribed for the patient. In this subsection, a textual description and date range for each plan of care is indicated, and any records associated with the plan of care may be accessible from the subsection by way of a suitable hyperlink. As with the other subsections described above, the “Go to Plan of Care” is equipped with an associated tab 141, the selection of which (in this case) launches a page from which each plan of care may be viewed in further detail.

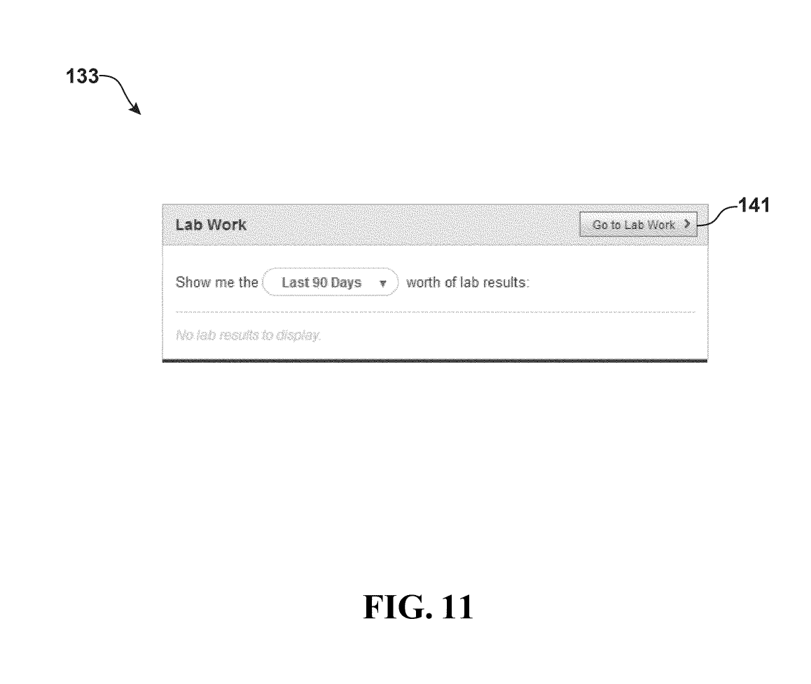

The lab work subsection 133, which is shown in greater detail in FIG. 11, provides a listing of any lab results obtained for the patient. The subsection is equipped with a date menu that allows the user to select a time period of interest. After selection of such a time period, all lab results returned within that period are displayed in the subsection, preferably with a textual description for each item returned and any associated dates. Any records associated with any lab results may be accessible from this subsection by way of suitable hyperlinks. Selection of any of the lab results listed launches a page in which details about the lab results are provided. In addition, a “Go to Lab Work” tab 141 is provided, the selection of which launches a page from which the lab results for the patient may be viewed in further detail.

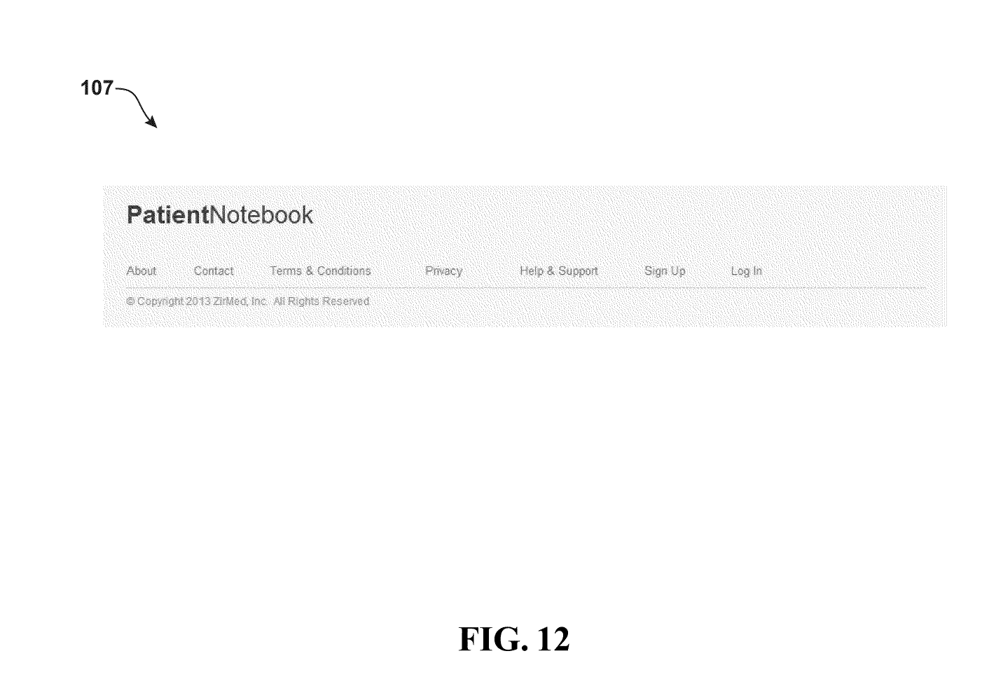

The patient notebook section 107, which is shown in greater detail in FIG. 12, provides a means by which the patient may keep any notes of interest regarding the patient's healthcare. The notebook section may include a diary section in which the patient or other authorized party may keep a dated journal of the patient's medical care. Entries into the diary may be made through any suitable means such as, for example, via keyboard entry, touchscreen technologies, voice recognition, or the like.

Various search and navigational aids may be provided to allow the user to efficiently browse, search and navigate the journal. Suitable means may also be provided for linking any relevant medical records to one or more entries. For example, a suitable identifier of the medical record may be entered into the notebook or an image or URL of the record may be pasted into the notebook, and the software may create any necessary or suitable hyperlinks to the corresponding records. This may allow, for example, entries regarding a patient's symptoms to be linked to the patient's medication to establish possible correlations between the two.

The foregoing systems and methodologies may be implemented by suitable hardware and software. Thus, for example, these systems and methodologies may be implemented by use of a tangible, non-transitory medium having suitable programming instructions recorded therein which, when acted upon by one or more processors, causes the systems and methods to be implemented. In various embodiments, the software utilized to implement these systems and methodologies may include a server from which the platform and any associated databases are maintained, and one or more clients which are distributed to the host devices of end users. Such host devices may include, but are not limited to, laptop or desktop PCs and mobile communications devices and platforms.

The platform described herein enables a variety of secondary healthcare services and analyses to be performed for the benefit of the patient. For example, the platform may be equipped with appropriate functionality to identify any gaps in a patient's medical records, and may generate recommendations for filling these gaps. Such gaps may be identified, for example, by the presence of healthcare records on the platform which imply the existence of other records not on the platform. For example, if a patient's insurance records indicate a claim for healthcare relating to a broken arm, and there are no corresponding medical records, the patient's medical records are likely incomplete.

The platform may also be provided with suitable functionality to analyze a patient's timeline and the associated records, and to make recommendations for suitable healthcare services, medications, healthcare education programs, healthcare insurance programs, or healthcare benefits based on this analysis. A similar analysis may be utilized to notify the patient of unfilled prescriptions, to notify the patient about potential drug interactions between prescriptions that have been given to the patient, to notify the patient about potential allergic reactions to drugs the patient may have been prescribed or environments the patient may be exposed to, or to notify the patient of the existence of generic versions of any drugs they are taking.

In some embodiments, the platforms, systems and methodologies described herein may be combined, or may be part of, an information exchange platform utilized by healthcare providers. One such exchange is described in U.S. Ser. No. 14/216,485 (Fielding et al.), entitled “Information Exchange for Health Care Providers”, which was filed on Mar. 17, 2014, and which is incorporated herein by reference in its entirety.

While the platforms, systems and methodologies described herein have been described in particular detail with respect to the organizational features they lend to a patient's healthcare history, it will be appreciated that these systems may also be utilized to perform a similar function with respect to a patient's healthcare expenses. In particular, these platforms, systems and methodologies may be utilized to store information about the expenses associated with different events along a patient's timeline.

It will also be appreciated from the foregoing that the systems described herein and the associated platforms are especially advantageous when they are associated with a revenue cycle management company. Since revenue cycle management companies are, by their nature, already established as intermediaries between insurance companies and healthcare providers, and hence already have access to the flow of healthcare and financial data flowing between these entities, revenue cycle management companies are uniquely suited to implement the platforms, systems and methodologies disclosed herein.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will further be appreciated that any of the subject matter set forth in any of the claims may be combined into various combinations and sub-combinations, whether or not such combinations and sub-combinations are explicitly set forth herein, without departing from the scope of the teachings herein. By way of example, the subject matter set forth in any combination of dependent claims may be combined into a single claim without departing from the scope of the teachings herein.

1. A method for providing online access to patient healthcare information, comprising:
receiving patient healthcare information electronically for each of a plurality of patients from a plurality of healthcare providers and from a plurality of healthcare payers, wherein said healthcare information includes clinical data and financial information relating to a healthcare event in which a patient received healthcare treatment for a condition;
providing a platform which is accessible online and which is equipped with a graphical user interface (GUI) in which (a) the healthcare events associated with each of the plurality of patients are arranged along a timeline, and (b) the healthcare information received for that patient is linked to the healthcare event to which it corresponds; and
providing online access to the platform to each of the plurality of patients.

2. The method of claim 1, wherein the GUI further graphically displays health and fitness trends for a patient.

3. The method of claim 1, wherein the healthcare events associated with each of the plurality of patients are arranged along the timeline in chronological order.

4. A tangible, non-transitory medium having suitable programming instructions recorded therein which, when acted upon by one or more processors, causes the method of claim 1 to be implemented.

5. (canceled)

6. The method of claim 1, further comprising a set of activities selected from the group consisting of (a) identifying gaps in a patient's healthcare by analyzing the timeline associated with the patient and the information linked thereto, and
generating recommendations for remedying the gaps; (b) identifying services appropriate for a patient by analyzing the timeline associated with the patient and the information linked thereto, and notifying the patient of the recommended services; (c) identifying medicines appropriate for a patient by analyzing the timeline associated with the patient and the information linked thereto, and notifying the patient of the recommended medicines, (d) identifying healthcare education programs appropriate for a patient by analyzing the timeline associated with the patient and the information linked thereto, and notifying the patient of the recommended healthcare education programs; (e) identifying incomplete records in the timeline associated with a patient by analyzing the timeline associated with the patient and the information linked thereto, and querying the plurality of healthcare providers or the plurality of insurance companies for the missing records; (f) identifying the healthcare providers or insurance companies likely to have the missing records by analyzing the timeline and the information linked thereto; and
querying the identified parties for the missing records, (g) identifying health insurance policies appropriate for a patient by analyzing the timeline associated with the patient and the information linked thereto, and notifying the patient of the recommended policies; and (h) identifying health insurance benefits available to a patient by analyzing the timeline associated with the patient and the information linked thereto, and notifying the patient of the identified benefits.

7-9. (canceled)

10. The method of claim 1, further comprising:
identifying incomplete records in the timeline associated with a patient by analyzing the timeline associated with the patient and the information linked thereto;
identifying the healthcare providers or insurance companies likely to have the missing records by analyzing the timeline and the information linked thereto; and
querying the identified parties for the missing records.

11-13. (canceled)

14. The method of claim 1, further comprising:
receiving a request from a patient for records associated with the patient; and
providing the patient with the requested records.

15. The method of claim 1, wherein the records are available as hyperlinks which are navigable from the patient's timeline, and wherein selecting the link corresponding to a record launches a page from which the record can be downloaded.

16. The method of claim 1, wherein the records are available as hyperlinks which are navigable from the patient's timeline, and wherein selecting the link corresponding to a record launches a page from which the record can be browsed.

17. The method of claim 1, further comprising:
identifying potential drug interactions for a patient by analyzing the timeline associated with the patient and the information linked thereto; and
notifying the patient of the identified drug interactions.

18. The method of claim 1, further comprising:
identifying prescriptions for a patient that have not been filled by analyzing the timeline associated with the patient and the information linked thereto; and
notifying the patient of the unfilled prescriptions.

19. The method of claim 1, further comprising:
identifying generic equivalents of medications that a patient is currently taking by analyzing the timeline associated with the patient and the information linked thereto; and
notifying the patient of the generic equivalents.

20. The method of claim 1, further comprising:
compiling a list of medications that a patient is potentially allergic to by analyzing the timeline associated with the patient and the information linked thereto;
when a record is added to a patient's timeline which indicates that a medication has been prescribed to the patient, determining whether the prescribed medication is on the list of medications that the patient is potentially allergic to; and
if the prescribed medication is on the list of medications that the patient is potentially allergic to, notifying the patient of the potential allergy.

21. The method of claim 1, further comprising:
compiling a list of medications that a patient is potentially allergic to by analyzing the timeline associated with the patient and the information linked thereto;
periodically analyzing a patient's timeline to determine if a medication has been prescribed to the patient that is on the list of medications that the patient is potentially allergic to; and
if a medication has been prescribed to the patient that is on the list of medications that the patient is potentially allergic to, notifying the patient of the potential allergy.

22. The method of claim 1, wherein the steps of receiving patient healthcare information and providing a platform are performed by a healthcare revenue cycle management company.

23. The method of claim 22, wherein the healthcare revenue cycle management company receives at least a portion of the patient healthcare information in the process of handling an insurance claim.

24. The method of claim 22, wherein the healthcare revenue cycle management company receives at least a portion of the patient healthcare information in the process of performing an action selected from the group consisting of (a) submitting insurance claims to insurance companies, (b) responding to insurance claim adjudications, (c) processing remittances received from healthcare payers, and (d) assessing patient eligibility for healthcare insurance benefits.

25-27. (canceled)

28. The method of claim 22, wherein the healthcare revenue cycle management company receives at least a portion of the patient healthcare information from a source selected from the group consisting of (a) a health information exchange, and (b) an electronic medical record.

29. (canceled)

30. The method of claim 1, further comprising:
receiving healthcare information from a patient who has been provided with online access to the platform;
identifying the healthcare event to which the information corresponds;
creating a record of the received healthcare information; and
linking the created record to the patient's timeline.

31. The method of claim 30, wherein receiving healthcare information from the patient includes:
providing a fillable online form for the patient to complete; and
creating the record from the information in the completed form.

32. The method of claim 21, wherein receiving healthcare information from the patient includes:
providing a page from which healthcare documents may be uploaded by a patient; and
creating the record from the information in the uploaded documents.

33. The method of claim 32, wherein creating the record from the information in the uploaded documents includes applying a text recognition protocol to the uploaded documents.

34. The method of claim 1, wherein the plurality of healthcare providers or the plurality of healthcare payers belong to a plurality of networks.

35. The method of claim 1, further comprising:
providing online access to a patient's timeline on the platform to a party selected from the group consisting of (a) parties authorized by the patient, and (b) healthcare providers associated with the patient.

36. (canceled)

37. The method of claim 1, wherein the platform comprises an application programming interface (API).

38. The method of claim 1, wherein the GUI includes electronic medical record (EMR) integration.

39. (canceled)

40. The method of claim 1, wherein the GUI comprises first and second GUIs, wherein the first GUI is accessible by patients, and wherein the second GUI is accessible by healthcare providers.

41. A method for collecting and presenting healthcare information, comprising:
collecting health records for a plurality of patients from a plurality of healthcare providers; and
for each patient, depicting the collected health records for that patient on a graphical user interface (GUI) which includes (i) a timeline showing a series of medical events for the patient, and (ii) for each medical event, a hyperlink to records associated with the medical event.
